(19) United States
(12) Patent Application Publication
(10) Pub. No.: US 2014/0142734 A1
(43) Pub. Date: May 22, 2014

(54) VIRTUAL SIGNAL SOURCE GENERATING APPARATUS AND METHOD THEREOF

(71) Applicant: C-MEDIA ELECTRONICS INC., Taipei City (TW)

(72) Inventors: HUNG-CHI HUANG, NEW TAIPEI CITY (TW); JUNG-FU LIAO, TAIPEI CITY (TW)

(73) Assignee: C-MEDIA ELECTRONICS INC., TAIPEI CITY (TW)

(21) Appl. No.: 13/802,932

(22) Filed: Mar. 14, 2013

(30) Foreign Application Priority Data
Nov. 21, 2012 (TW) 101143425

(51) Int. Cl. G06F 3/16

(52) U.S. Cl. CPC G06F 3/16
USPC 700/94

(57) ABSTRACT

A virtual signal source generating apparatus is provided. The virtual signal source generating apparatus includes at least an audio interface, a control module, a detecting module and a processing module. The control module is used for acquiring an audio signal from a signal source, wherein the audio signal includes a clock information and an audio information. The detecting module is used for detecting whether the audio interface is coupled to the signal source. The processing module is used for transmitting the audio signal. If the detecting module detects that the signal source disappears when the virtual signal source generating apparatus is in the recording mode, the control module transmits a control signal to the processing module so that the processing module transmits a virtual audio signal to a host.

### BACKGROUND OF THE DISCLOSURE

1. Field of the Disclosure

The instant disclosure relates to an audio connecting apparatus; in particular, to a virtual signal source generating apparatus.

2. Description of Related Art

With a continuous advancement in technology, an electronic connecting apparatus is a mainly used as a switching element in transmitting electronic signals for a variety of electronic products, wherein an audio connecting apparatus, specifically used for an audio signal to input/output, has been broadly used in all kinds of video and audio products such as mobile phones, personal digital assistants (PDA), MP3 players, Voice recorders, laptops, Apple iPods, and also audio connectors of different sizes.

Under a recording mode, because a host is in an active state, the host collects information from a passive audio connecting apparatus actively. During a recording process, if a signal source connected to the audio connecting apparatus is unplugged or disappearing, the information transmitted will be discontinuous or even cut off, and further leads the host crashed and thus a user is not able to have the host process other tasks smoothly.

### SUMMARY OF THE DISCLOSURE

The instant disclosure provides a virtual signal source generating apparatus, and the virtual signal source generating apparatus includes at least an audio interface, a control module, a detecting module and a processing module. The audio interface is coupled to at least a signal source. The control module is coupled to the audio interface, acquiring an audio signal from a signal source, wherein the audio signal includes a clock information and an audio information. The detecting module is coupled to the audio interface and the control module, detecting if the audio interface is coupled to the signal source. The processing module is coupled to the control module, transmitting the audio signal. If the detecting module detects that the signal source disappears when the virtual signal source generating apparatus is under a recording mode, the control module transmits a control signal to the processing module so that the processing module transmits a virtual audio signal to a host.

In an embodiment of the instant disclosure, the signal source is an electronic apparatus.

In an embodiment of the instant disclosure, the host acquires a sampling length information from the clock information of the audio signal so as to sample the audio signal according to the sampling length information for the recording.

In an embodiment of the instant disclosure, the content of the virtual audio signal may be a mute content or a pre-state maintain content, and the virtual audio signal is coincident with the sampling length information of the host.

In an embodiment of the instant disclosure, the pre-state maintain content is defined as an audio content repeated with the last sampling point of the audio signal before the signal disappears.

In an embodiment of the instant disclosure, when the detecting module detects that the audio signal representing the signal source which transmitting an identical but disappearing audio signal appears again, the control module transmits the control signal to the processing module so that the processing module continuously transmits the audio signal to the host.

The instant disclosure provides a virtual signal source generating method, the virtual signal source generating method includes steps as follows: detecting if there is at least a signal source; determining if the signal source disappears; transmitting an audio signal to a host if the signal source does not disappear; generating a virtual audio signal and transmitting the virtual audio signal to the host if the signal source disappears, wherein the virtual signal source generating apparatus generating the virtual audio signal is under a recording mode, and the audio signal includes a clock information and an audio information.

In an embodiment of the instant disclosure, the signal source of the virtual signal source generating method is an electronic apparatus.

In an embodiment of the instant disclosure, the host acquires a sampling length information from the clock information of the audio signal so as to sample the audio signal according to the sampling length information for the recording.

In an embodiment of the instant disclosure, the content of the virtual audio signal may be a mute content or a pre-state maintain content, and the virtual audio signal is coincident with the sampling length information of the host.

In an embodiment of the instant disclosure, the pre-state maintain content is defined as an audio content repeated with the last sampling point of the audio signal before the signal disappears.

In an embodiment of the instant disclosure, when the detecting module detects that the audio signal representing the signal source which transmitting an identical but disappearing audio signal appears again, the control module transmits the control signal to the processing module so that the processing module continuously transmits the audio signal to the host.

To sum up, when the signal resource received by the audio interface disappears under the recording mode, the virtual signal source generating apparatus and the method thereof are able to automatically generate a virtual audio signal with a coincident sampling length information as the audio signal, and transmits the virtual audio signal to the host to allow the host to be able to keep acquiring the audio information from the virtual signal source generating apparatus, and further allows the host to operate as usual instead of being crashed. Accordingly, when the user is using the host to acquire the audio information for recording, the host may even be multi-functioned for convenience and efficiency, which explains that the host is prevented from being crashed and failing to process other tasks smoothly.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

Accompanying drawings are referred to the descriptions above for a specific instruction of embodiments of the instant disclosure, and thereby the disclosure is able to be understood in detail. In the drawings:

FIG. 1 shows a block diagram of a virtual signal source generating apparatus according to an embodiment of the instant disclosure;

FIG. 2 shows a block diagram of a virtual signal source generating apparatus according to an embodiment of the instant disclosure;

FIG. 3 shows a flow chart of a virtual signal source generating method according to the embodiment of the instant disclosure;

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the instant disclosure. As used herein, the term “and/or” includes any and all combinations of one or more of the associated listed items.

It is to be understood that, when an element is “connected” or “coupled” to another element, the element may be directly connected or coupled to the other element, or there may be a case that one of the elements is inserted to the other. On the contrary, when an element is “directly connected” or “directly coupled” to another element, then there will not be any element is inserted. A way of explaining a relation between elements as described above should be applied into other descriptions such as “between” versus “directly between, “adjacent” versus “directly adjacent.”

[Embodiment of a Virtual Signal Source Generating Apparatus]

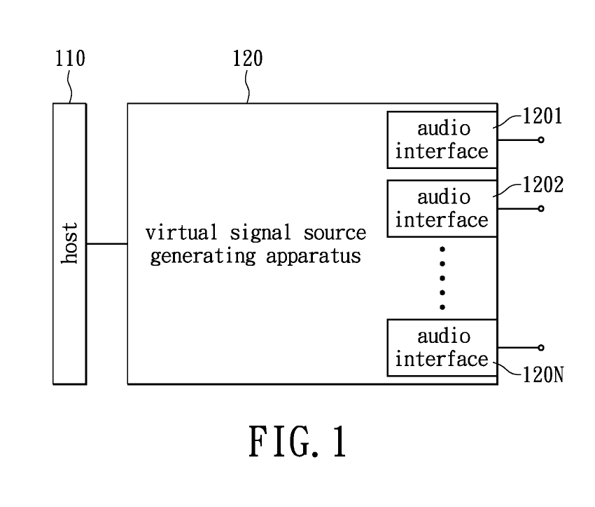

Referring to FIG. 1, FIG. 1 shows a block diagram of a virtual signal source generating apparatus 120 according to an embodiment of the instant disclosure. As shown in FIG. 1, the virtual signal source generating apparatus 120 includes a plurality of audio interface 1201˜120N, wherein N is an integer, and the virtual signal source generating apparatus 120 is coupled to a host 110, and the host 110 has an operating system. In the present embodiment, the plurality of the audio interface 1201˜120N may be in a Sony/Philips Digital Interface Format (S/PDIF) or in an audio jack, and it is not limited either in only one format or limited in the formats shown in the present embodiment. People skilled in the arts should be aware that the S/PDIF is a digital code transmission interface, mainly used in outputting an audio to a decoder through an optical fiber and a coaxial cable with a high quality that the audio outputted is close to the original, and has been broadly applied into digital theater systems (DTS) and a Dolby digital code. A difference between the S/PDIF and an Inter-IC Sound or Integrated Interchip Sound (I2S) is that the S/PDIF is able to transmit through a single line. In other words, the S/PDIF is able to include an audio information and a clock information. There is further instruction for related operation of the embodiment in FIG. 1 as recited below.

Continuously referring to FIG. 1, under a recording mode, the host 110 collects the information from virtual signal source generating apparatus 120 actively; which means, the host is in an active state, and the virtual signal source generating apparatus 120 is in a passive state. To prevent a situation in prior arts that the host crashed because of a signal source unplugged or disappearing from happening, in the present embodiment, the virtual signal source generating apparatus 120 is able to automatically detect if the signal source is unplugged or disappearing. If the signal source coupled to the audio interface 1201-120N has disappeared (the original signal source suddenly disappears), the virtual signal source generating apparatus 120 generates a virtual audio signal automatically, and transmits the virtual audio signal to the host 110 so that the host 110 is able to acquire the audio information from the virtual signal source generating apparatus 120 since then, wherein a content of the audio signal may be further designed by a designer according to an actual application demand. It is worth noticing that the virtual signal source generating apparatus 120 provides a virtual audio signal as the audio signal to allow the host 110 in the active state to be able to keep acquiring the audio information from the virtual signal source generating apparatus 120 under the recording mode, and further to allow the host 110 to operate as usual instead of being crashed. Accordingly, when the user is using the host 110 to acquire the audio information for recording, the host 110 may even be multi-functioned for convenience and efficiency, which explains that the host 110 is prevented from being crashed and failing to process other tasks smoothly.

For an easy instruction and understanding, in the following embodiments, the S/PDIF is taken as an example to instruct the content of the instant disclosure. In addition, to teach an operation flow of the virtual signal source generating apparatus of the instant disclosure, another drawing is referred for further detailed instruction. The embodiment below is meant for a comprehensive understanding of the instant disclosure, not to limit the instant disclosure.

In the embodiments recited as below, there are only parts different from the embodiment in the FIG. 1 described, and the omitted parts are indicated to be identical to the parts of the embodiment in the FIG. 1. Furthermore, to simply the instruction, similar referred numbers or symbols are indicated to be elements alike.

[Embodiment of a Virtual Signal Source Generating Apparatus]

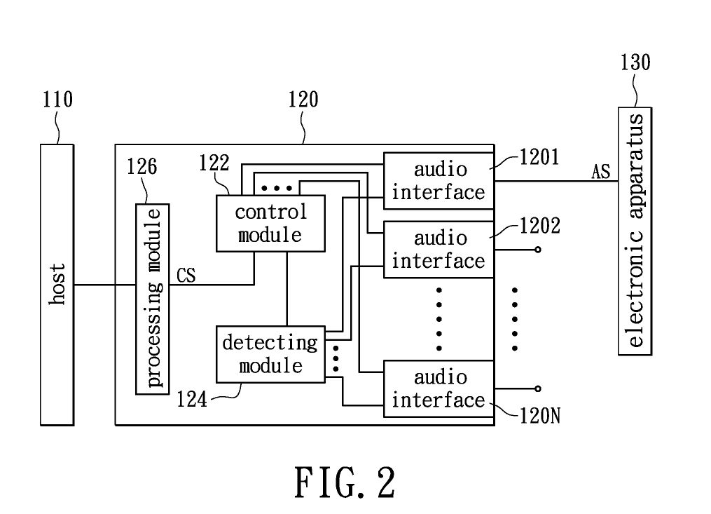

Referring to FIG. 2, FIG. 2 shows a block diagram of a virtual signal source generating apparatus 120 according to an embodiment of the instant disclosure. As shown in FIG. 2, different from the embodiment in the FIG. 1, the virtual signal source generating apparatus 120 further includes a control module 122, a detecting module 124, and a processing module 126. The control module 122 is coupled to a plurality of audio interface 1201-120N. The detecting module 124 is coupled to the plurality of the audio interface 1201-120N and the control module 122. The processing module 126 is coupled to the control module 122.

The control module 122 is used for acquiring an audio signal AS in a signal source, wherein the audio signal AS includes a clock information and an audio information, and in the present embodiment, the signal source may be an electronic apparatus 130 or another apparatus, such as an audio voice (AV) amplifier, or a digital video disc (DVD) player, which is able to generate the audio signal AS, and it is not limited thereto. The detecting module 124 is used for detecting if the plurality of the audio interface 1201-120N is coupled to the signal source; which means, the detecting module 124 detects if the plurality of the audio interface 1201-120N receives the audio signal AS in the signal source. The processing module 126 transmits the audio signal AS to a host 110 or generates a virtual audio signal and then transmits the virtual audio signal to the host 110. It is to be noticed that, in the present embodiment, it is either the audio signal AS or the virtual audio signal; in other words, it is not possible for the processing module 126 to transmit the audio signal AS and the virtual audio signal to the host 110 simultaneously. In the present embodiment, when the host 110 and the virtual signal source generating apparatus 120 are under a recording mode, if the detecting module 124 detects that the signal source is unplugged or disappearing, the control module 122 transmits a control signal CS to the processing module 126 so as to have the processing module 126 generate and transmit the virtual audio signal to the host 110.

Moreover, there is further teaching about specific operation of the embodiment in the FIG. 2; however, before proceeding instruction, it is to be clarified that, the embodiment is taken an example of the audio interface 1201 receiving the electronic apparatus 130 (i.e. the signal source) to instruct, and the audio interface 1201 is in a S/PDIF. People skilled in the arts may be able to make applications to various audio interfaces, which are within a scope of the instant disclosure.

Continuously referring to FIG. 2, in a comparison to prior arts, the host 110 under the recording mode may constantly be crashed due to the signal source unplugged or disappearing; therefore, the instant disclosure provides an operation mechanism which prevents the host 110 from being crashed and causing a user may further be affected in processing other tasks with the host 110. Under the recording mode, the electronic apparatus 130 (i.e. the signal source of the audio signal AS) transmits the audio signal AS to the audio interface 1201; at the moment, the audio interface 1201 decodes the audio signal AS with a decoder so as to achieve a higher quality audio. In the meantime, the detecting module 124 continuously detects if the electronic apparatus 130 coupled to the audio interface 1201 is off a coupling; which means, the detecting module 124 detects if the signal source transmitting the audio signal AS to the audio interface 1201 is unplugged or disappearing, and the detecting module 124 feeds a detecting result back to the control module 122.

When the detecting result shows that the signal source is not unplugged, fallen off, or disappearing, the control module 122 transmits the audio signal AS decoded and the control signal CS to the processing module 126 so that the processing module 126 is able to transmit the audio signal AS decoded to the host 110 to process the recording. The audio signal AS includes the clock information and the audio information; therefore, the host 110 is able to acquire a sampling length information from the clock information of the audio signal AS, and the sampling length information is a sampling rate. For example, in an embodiment, the sampling rate is 48 sampling points per second. Afterwards, the host 110 samples the audio signal according to a sampling length information for the recording.

On the other hand, when the detecting result is that the signal source is unplugged, fallen off, or disappearing, the control module 122 transmits the control signal CS to the processing module 126. After the processing module 126 receives an operation command from the control signal CS, the virtual audio signal with a coincident sampling length information is generated according to the operation command of the control signal CS, and the audio signal is transmitted to the host 110 to allow the host 110 in the active mode to keep acquiring related a bit data of the virtual audio signal for the recording, and the host 110 is able to be operated as usual instead of being crashed. Accordingly, when the user uses the host 110 to acquire the audio information for the recording, the host 110 may be multi-functioned for convenience and efficiency, which explains that the host 110 is prevented from being crashed and failing to process other tasks smoothly. In addition, a content of the virtual audio signal may further be designed by the user according to an actual demand; in the present embodiment, the content of the virtual audio signal may be a mute content or a pre-state maintain content, and the so called “pre-state maintain content” is defined as an audio content repeated with the last sampling point of the audio signal AS before the signal disappears; however, it is not limited thereto.

It is to be noticed that the detecting module 124 still keeps detecting if the audio interface 1201 is in a state of being coupled to the signal source to receive audio signal AS at the moment. If the audio interface 1201 is back coupled to the electronic apparatus 130 and receives the audio signal AS transmitted by the electronic apparatus 130, the control module 122 transmits the audio signal AS decoded and the control signal CS to the processing module 126 according to the detecting result, and the processing module 126 stops generating the virtual audio signal and transmits the audio signal AS decoded to the host 110 for the recording.

Briefly, ideas which are relative to generating a virtual audio signal to the host when the signal source disappears are within the scope of the technique and the idea of the instant disclosure.

[Embodiment of a Virtual Signal Source Generating Apparatus]

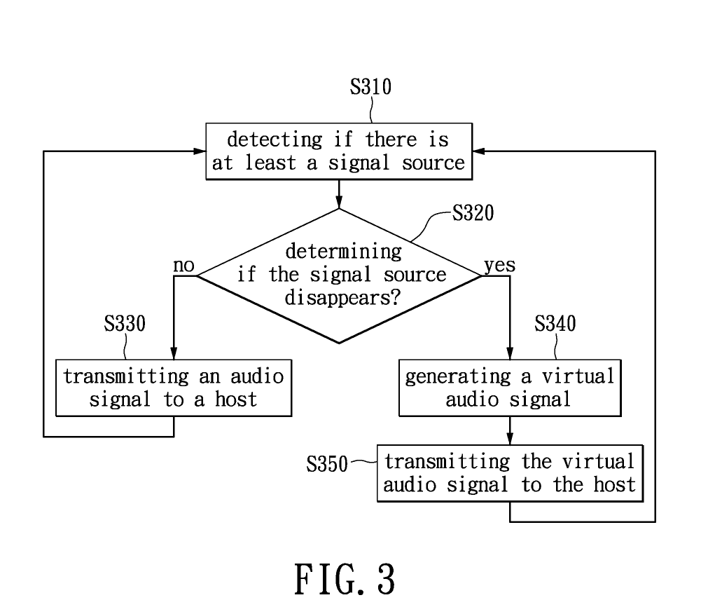

Referring to FIG. 3, FIG. 3 shows a flow chart of a virtual signal source generating method according to the embodiment of the instant disclosure. For further understanding of the flow chart and the content of the instant disclosure, please refer to the schematic diagrams of the virtual signal source generating apparatus in FIGS. 1-2. The virtual signal source generating method includes steps as follows: detecting if there is at least a signal source (S310); determining if the signal source disappears (S320); transmitting an audio signal to a host if the signal source does not disappear (S330); generating a virtual audio signal and transmitting the virtual audio signal to the host if the signal source disappears (S340 and S350), wherein the virtual signal source generating apparatus generating the virtual audio signal is under a recording mode, and the audio signal includes a clock information and an audio information. Details about the virtual signal source generating method are described specifically in the embodiments of the FIGS. 1-2, and it is not repeated thereto.

It is to be explained that the steps of the embodiment in the FIG. 3 are set for a need to instruct easily, and thus a sequence of the steps in the present embodiment is not used as a limit condition in demonstrating the embodiments of the instant disclosure.

To sum up, when the signal resource received by the audio interface disappears under the recording mode, the virtual signal source generating apparatus and the method thereof are able to automatically generate a virtual audio signal with a coincident sampling length information as the audio signal, and transmits the virtual audio signal to the host to allow the host to be able to keep acquiring the audio information from the virtual signal source generating apparatus, and further allows the host to operate as usual instead of being crashed. Accordingly, when the user is using the host to acquire the audio information for recording, the host may even be multi-functioned for convenience and efficiency, which explains that the host is prevented from being crashed and failing to process other tasks smoothly.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A virtual signal source generating apparatus, comprising:
at least an audio interface, coupled to at least a signal source;
a control module, coupled to the audio interface, acquiring an audio signal from a signal source, wherein the audio signal comprises a clock information and an audio information
a detecting module, coupled to the audio interface and the control module, detecting whether the audio interface is coupled to the signal source; and
a processing module, coupled to the control module, transmitting the audio signal;
wherein if the detecting module detects that the signal source disappears when the virtual signal source generating apparatus is under a recording mode, the control module transmits a control signal to the processing module so that the processing module transmits a virtual audio signal to a host.

2. The virtual signal source generating apparatus according to claim 1, wherein the signal source is an electronic apparatus.

3. The virtual signal source generating apparatus according to claim 1, wherein the host acquires a sampling length information from the clock information of the audio signal so as to sample the audio signal according to the sampling length information for the recording.

4. The virtual signal source generating apparatus according to claim 3, wherein the content of the virtual audio signal may be a mute content or a pre-state maintain content, and the virtual audio signal is coincident with the sampling length information of the host.

5. The virtual signal source generating apparatus according to claim 4, wherein the pre-state maintain content is defined as an audio content repeated with the last sampling point of the audio signal before the signal disappears.

6. The virtual signal source generating apparatus according to claim 1, wherein when the detecting module detects that the audio signal representing the signal source which transmitting an identical but disappearing audio signal appears again, the control module transmits the control signal to the processing module so that the processing module continuously transmits the audio signal to the host.

7. A virtual signal source generating method, comprising
detecting if there is at least a signal source;
determining if the signal source disappears;
transmitting an audio signal to a host if the signal source does not disappear; and
generating a virtual audio signal and transmitting the virtual audio signal to the host if the signal source disappears,
wherein the virtual signal source generating apparatus generating the virtual audio signal is under a recording mode, and the audio signal includes a clock information and an audio information,
wherein the virtual signal source generating method is applied to the virtual signal source generating apparatus according to claim.

8. The virtual signal source generating method according to claim 7, wherein the signal source is an electronic apparatus.

9. The virtual signal source generating method according to claim 7, wherein the host acquires a sampling length information from the clock information of the audio signal so as to sample the audio signal according to the sampling length information for the recording.

10. The virtual signal source generating method according to claim 9, wherein the content of the virtual audio signal may be a mute content or a pre-state maintain content, and the virtual audio signal is coincident with the sampling length information of the host.

11. The virtual signal source generating method according to claim 10, wherein the pre-state maintain content is defined as an audio content repeated with the last sampling point of the audio signal before the signal disappears.

12. The virtual signal source generating method according to claim 7, wherein when the detecting module detects that the audio signal representing the signal source which transmitting an identical but disappearing audio signal appears again, the control module transmits the control signal to the processing module so that the processing module continuously transmits the audio signal to the host.
